(19) United States
(12) Patent Application Publication
(10) Pub. No.: US 2023/0040981 A1
(43) Pub. Date: Feb. 9, 2023

(54) SELF-CONTAINED HYDROGEN POWER SYSTEM FOR ELECTRIC CAR CHARGING STATION

(71) Applicant: KWaterCraft Co., Ltd., Busan (KR)

(72) Inventors: Soon Pyo Kwon, Busan (KR); Jong-Hwa Kim, Busan (KR)

(73) Assignee: KWaterCraft Co., Ltd., Busan (KR)

(21) Appl. No.: 17/444,651

(22) Filed: Aug. 6, 2021

(51) Int. Cl. H01M 8/0656; H01M 8/0662; H02S 40/22; H01M 16/00

(52) U.S. Cl. CPC H01M 8/0656; H01M 8/0687; H02S 40/22; H01M 16/003; H01M 2250/20

(57) ABSTRACT

Disclosed are a self-contained hydrogen power system and method for an electric car charging station. The self-contained hydrogen power system may include a high-level water purification unit configured to retain storm water, seawater or portable water in a water reserve tank, remove precipitates from the storm water, seawater or portable water, and perform water treatment on the storm water, seawater or portable water, a solar water electrolysis unit configured to generate clean hydrogen through hydrogen electrolysis and store the clean hydrogen, an energy production and storage unit configured to convert the clean hydrogen into energy through a fuel cell and perform an energy production and storage process by using energy generated by a sunlight collector, and a charging station configured to receive the energy stored in the energy production and storage unit and use the energy to charge an electric car.

### TECHNICAL FIELD

The present disclosure relates to a self-contained hydrogen power system for an electric car charging station.

### BACKGROUND OF THE INVENTION

In order to prepare the breakage of a water circulation system in an urban area, research related to the healthiness of city water circulation and the construction of a distributed type water management system is actively carried out. However, an efficient system and technology for using collected storm water is now insufficient. Furthermore, power supply in Korea is based on a centralized energy supply system, but a nuclear power plant that occupies about 30% of total supply power experiences accidents and failures every year. Correspondence upon peak time or blackout is not sufficient. A current electric car charging station uses electricity supplied by Korean electric power corporation (KEPCO). Cars can be charged only a restricted area due to the limitation of an electricity supply system.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

An object of the present disclosure is to provide a system for improving a supply situation of a charging station for an electric car by supplying electricity to an electric car charging station through an eco-friendly local distributed green energy supply system.

In an aspect, a self-contained hydrogen power system for an electric car charging station may include a high-level water purification unit configured to retain storm water, seawater or portable water in a water reserve tank, remove precipitates from the storm water, seawater or portable water, and perform water treatment on the storm water, seawater or portable water, a solar water electrolysis unit configured to generate clean hydrogen through hydrogen electrolysis and store the clean hydrogen, an energy production and storage unit configured to convert the clean hydrogen into energy through a fuel cell and perform an energy production and storage process by using energy generated by a sunlight collector, and a charging station configured to receive the energy stored in the energy production and storage unit and use the energy to charge an electric car.

The high-level water purification unit may primarily filters the storm water, seawater or portable water through a screen within the water reserve tank, may secondarily filter the storm water, seawater or portable water through a filter, may thirdly filter and purify the storm water, seawater or portable water through UV and a membrane filter, and may perform a treatment process for each use through consecutive processes including sedimentation, filtration, activated carbon adsorption, reverse osmosis, and high oxidation.

The solar water electrolysis unit may perform the hydrogen electrolysis by using solar thermal energy, may convert, into high-purity clean hydrogen, the hydrogen generated through the hydrogen electrolysis through a hydrogen purification process, may store the high-purity clean hydrogen in a hydrogen tank, and may periodically inject a predetermined amount of clean hydrogen into the energy production and storage unit through an automatic control panel, wherein the automatic control panel analyzes and controls required power versus solar power generation efficiency upon hydrogen electrolysis.

The energy production and storage unit may transfer, to a battery management system (BMS), the energy converted from the injected clean hydrogen through the fuel cell and the energy generated by the sunlight collector, may control optimum energy production and storage through interoperation with an automatic control panel of the solar water electrolysis unit, wherein power generated by a stack of the fuel cells is stored in an energy storage device and used as emergency power, may evaluate a storage state of dump power produced by the fuel cell, convert, into AC, power produced as DC, and may store the AC.

In another aspect, a self-contained hydrogen power method for an electric car charging station may include steps of retaining storm water, seawater or portable water in a water reserve tank of a high-level water purification unit and performing water treatment on the storm water, seawater or portable water by removing precipitates, injecting purified water into a solar water electrolysis unit, generating clean hydrogen through hydrogen electrolysis, and storing the clean hydrogen, injecting the clean hydrogen into an energy production and storage device, converting the clean hydrogen into energy through a fuel cell, and performing an energy production and storage process on the clean hydrogen by using energy generated by a sunlight collector, and receiving the energy stored in the energy production and storage unit through a charging station and using the energy to charge an electric car.

According to embodiments of the present disclosure, a charging station supply network situation for an electric car can be improved by supplying electricity to an electric car charging station through the eco-friendly local distributed green energy supply system.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a diagram illustrating a configuration of a self-contained hydrogen power system for an electric car charging station according to an embodiment of the present disclosure.

FIG. 2 is a flowchart for describing the self-contained hydrogen power method for an electric car charging station according to an embodiment of the present disclosure.

FIG. 3 is a diagram for describing a high-level water purification unit according to an embodiment of the present disclosure.

FIG. 4 is a diagram for describing a solar water electrolysis unit according to an embodiment of the present disclosure.

FIG. 5 is a diagram for describing an energy production and storage unit according to an embodiment of the present disclosure.

FIG. 6 is a diagram for describing an operating process of the self-contained hydrogen power system for an electric car charging station according to an embodiment of the present disclosure.

FIG. 7 is a diagram illustrating a charging station according to an embodiment of the present disclosure.

### DETAILED DESCRIPTION

While illustrative embodiments have been illustrated and described, it will be appreciated that various changes can be made therein without departing from the spirit and scope of the invention.

The present disclosure relates to a system for improving a supply situation of a charging station for an electric car by supplying electricity to an electric car charging station through an eco-friendly local distributed green energy supply system, and can optimize energy efficiency and supply emergency power upon peak time or blackout by using a smart grid and a power storage device along with the system. Storm water and seawater are retained, high-level water purification treatment, and hydrogen is generated using a water electrolysis device. The generated clean hydrogen is stored in a hydrogen tank, and produces power through a fuel cell. The generated energy, together with solar thermal energy using a solar panel, is stored in an energy storage system. All processes are controlled by an automatic control panel. Hereinafter, embodiments of the present disclosure are described in detail with reference to the accompanying drawings.

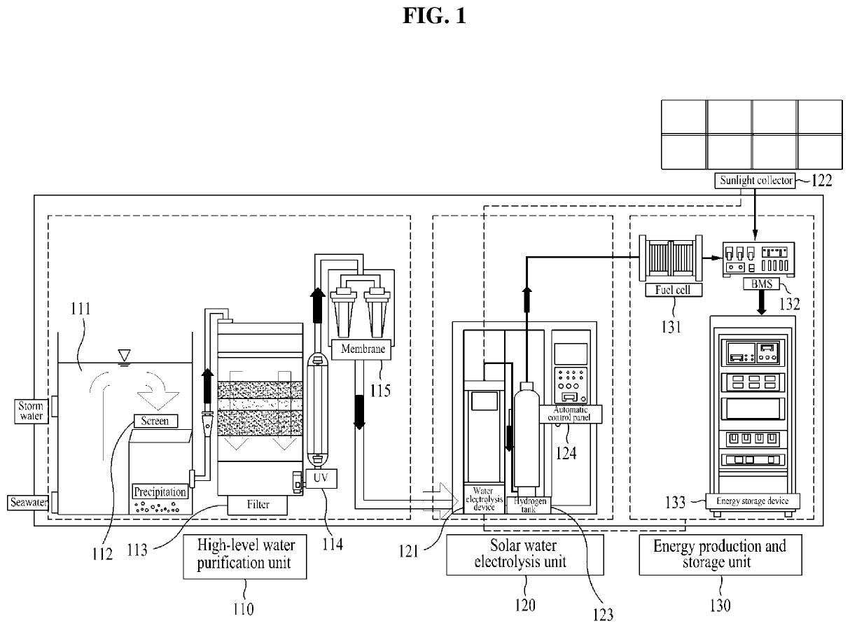

FIG. 1 is a diagram illustrating a configuration of a self-contained hydrogen power system for an electric car charging station according to an embodiment of the present disclosure.

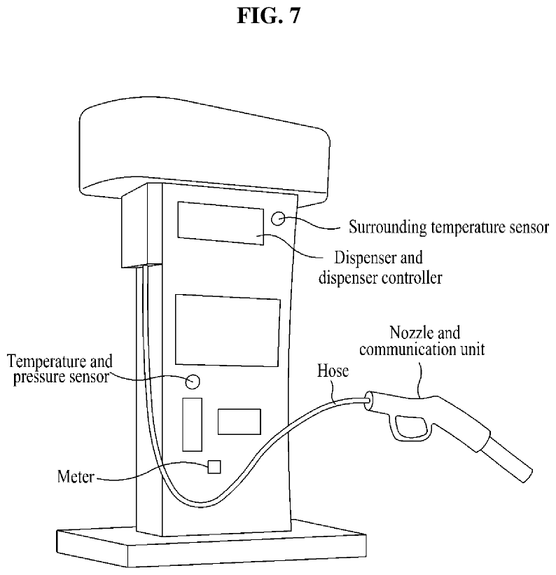

The proposed self-contained hydrogen power system for an electric car charging station includes a high-level water purification unit 110, a solar water electrolysis unit 120, an energy production and storage unit 130 and a charging station (refer to FIG. 7).

The high-level water purification unit 110 has storm water, seawater or portable water stored in a water reserve tank 111, and performs water treatment on the storm water, seawater or portable water by removing precipitates. The high-level water purification unit 110 primarily filters storm water, seawater or portable water through a screen 112 within the water reserve tank 111, secondarily filters the storm water, seawater or portable water through a filter 113, and then thirdly filters and purifies the storm water, seawater or portable water through ultraviolet rays (UV) 114 and a membrane filter 115. In this case, a treatment process for each use is performed using consecutive processes, including condensation, sedimentation, filtration, activated carbon adsorption, reverse osmosis, and high oxidation.

Purified water is introduced into the solar water electrolysis unit 120. A water electrolysis device 121 generates clean hydrogen through hydrogen electrolysis and stores the clean hydrogen in a hydrogen tank 123. The water electrolysis device 121 treats hydrogen electrolysis by using solar thermal energy generated by a sunlight collector 122. The hydrogen generated through hydrogen electrolysis is converted into high-purity clean hydrogen through a hydrogen purification process and is stored in the hydrogen tank 123. A predetermined amount of clean hydrogen is periodically injected into the energy production and storage unit 130 through tan automatic control panel 124. The automatic control panel 124 analyzes and controls required power versus solar power generation efficiency upon hydrogen electrolysis.

Clean hydrogen is injected into the energy production and storage unit 130. The energy production and storage unit 130 converts the hydrogen into energy through the fuel cell 131, and performs an energy production and storage process by using energy generated by a sunlight collector 122. The energy production and storage unit 130 transfers, to a battery management system (BMS) 132, the energy converted from the injected clean hydrogen through the fuel cell 131 and energy generated by the sunlight collector 122, and controls optimum energy production and storage through interoperation with the automatic control panel 124 of the solar water electrolysis unit 120. Power produced through a stack of the fuel cells 131 is stored in an energy storage device 133 and used as emergency power. The energy production and storage unit 130 evaluates a storage state of dump power produced by the fuel cell 131, converts, into AC, power produced as DC, and stores the AC.

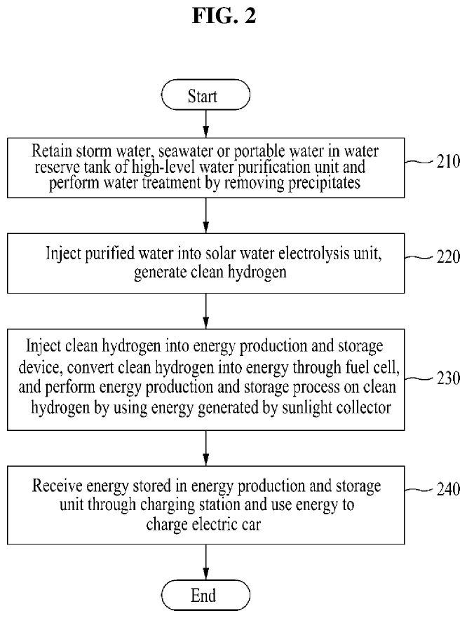

FIG. 2 is a flowchart for describing the self-contained hydrogen power method for an electric car charging station according to an embodiment of the present disclosure.

A proposed self-contained hydrogen power method for an electric car charging station includes step 210 of retaining storm water, seawater or portable water in the water reserve tank of the high-level water purification unit and performing water treatment on the storm water, seawater or portable water by removing precipitates, step 220 of injecting purified water into the solar water electrolysis unit, generating clean hydrogen through hydrogen electrolysis, and storing the clean hydrogen, step 230 of injecting the clean hydrogen into the energy production and storage device, converting the clean hydrogen into energy through the fuel cell, and performing an energy production and storage process on the clean hydrogen by using energy generated by the sunlight collector, and step 240 of receiving energy stored in the energy production and storage unit through a charging station and using the energy to charge an electric car.

In step 210, storm water, seawater or portable water is retained in the water reserve tank of the high-level water purification unit. Water treatment is performed on the storm water, seawater or portable water by removing precipitates. The storm water, seawater or portable water is primarily filtered through the screen within the water reserve tank, secondarily filtered through the filter, and then thirdly filtered and purified through the UV and the membrane filter. Furthermore, a treatment process for each use is performed through consecutive processes, including condensation, sedimentation, filtration, activated carbon adsorption, reverse osmosis, and high oxidation.

In step 220, the purified water is introduced into the solar water electrolysis unit and generated as clean hydrogen through hydrogen electrolysis. The clean hydrogen is stored. The hydrogen electrolysis is processed using solar thermal energy. Hydrogen generated by the hydrogen electrolysis is converted into high-purity clean hydrogen through a hydrogen purification process and is stored in the hydrogen tank. Thereafter, a predetermined amount of clean hydrogen is periodically injected into the energy production and storage unit through the automatic control panel. The automatic control panel analyzes and controls required power versus solar power generation efficiency upon hydrogen electrolysis.

In step 230, the clean hydrogen is injected into the energy production and storage unit and is converted into energy through the fuel cell. An energy production and storage process is performed using energy generated by the sunlight collector. The energy converted from the injected clean hydrogen through the fuel cell and the energy generated by the sunlight collector are transferred to the BMS. Optimum energy production and storage is controlled through interoperation with the automatic control panel of the solar water electrolysis unit. Power generated through a stack of the fuel cells is stored in the energy storage device and used as emergency power. The energy production and storage unit evaluates a storage state of dump power produced by the fuel cell, converts, into AC, power produced as DC, and stores the AC.

In step 240, the energy stored in the energy production and storage unit is received through the charging station and used to charge an electric car.

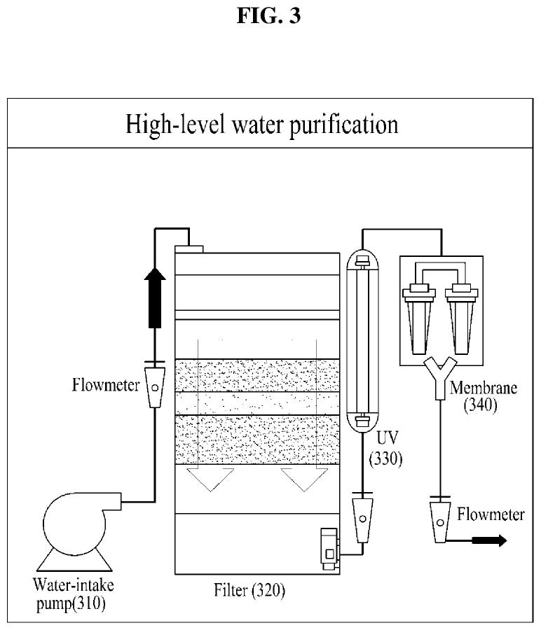

FIG. 3 is a diagram for describing a high-level water purification unit according to an embodiment of the present disclosure.

In the high-level water purification unit according to an embodiment of the present disclosure, storm water, seawater, or portable water is retained in a water reserve tank, and precipitates are filtered out. The storm water, seawater, or portable water is primarily filtered through a screen within the water reserve tank. Water supplied through a water-intake pump 310 is secondarily filtered through a filter 320. Thereafter, the water is thirdly filtered and purified through UV 330 and a membrane filter 340. In the present disclosure, emphasis is placed on a treatment process for each water use. A treatment process is performed through consecutive processes, including sedimentation, filtration, activated carbon adsorption, reverse osmosis, and high oxidation. A reactor is designed by considering a treatment level of a target value, an optimum injection concentration, light intensity, a contact time, or a characteristic for each water quality factor. Furthermore, system performance can be maintained with high efficiency for a long time by making, as a manual, timing at which each treatment target material is controlled, maintained and managed in an individual unit element system.

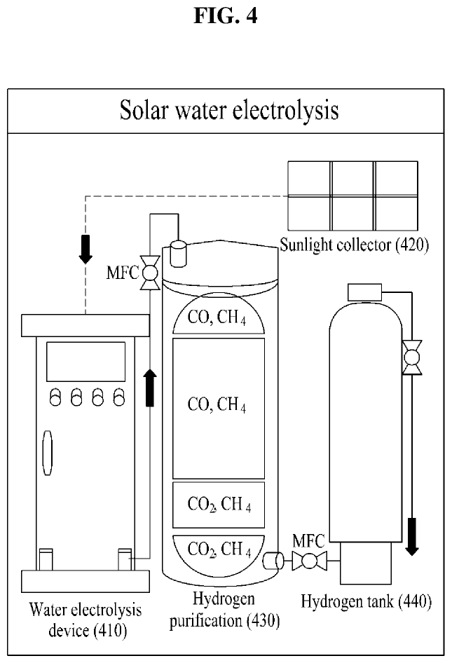

FIG. 4 is a diagram for describing a solar water electrolysis unit according to an embodiment of the present disclosure.

In the solar water electrolysis unit according to an embodiment of the present disclosure, purified water is introduced into a water electrolysis device 410. Hydrogen electrolysis is performed on the purified water, thereby generating clean hydrogen. The water electrolysis process is efficiently performed using solar thermal energy generated by a sunlight collector 420. The generated hydrogen is converted into high-purity clean hydrogen through a process for hydrogen purification 430 and stored in a hydrogen tank 440. Thereafter, a given amount of hydrogen is periodically injected into the energy production and storage unit through the automatic control panel. Upon water electrolysis, the automatic control panel efficiently performs required power versus solar power generation efficiency through analysis.

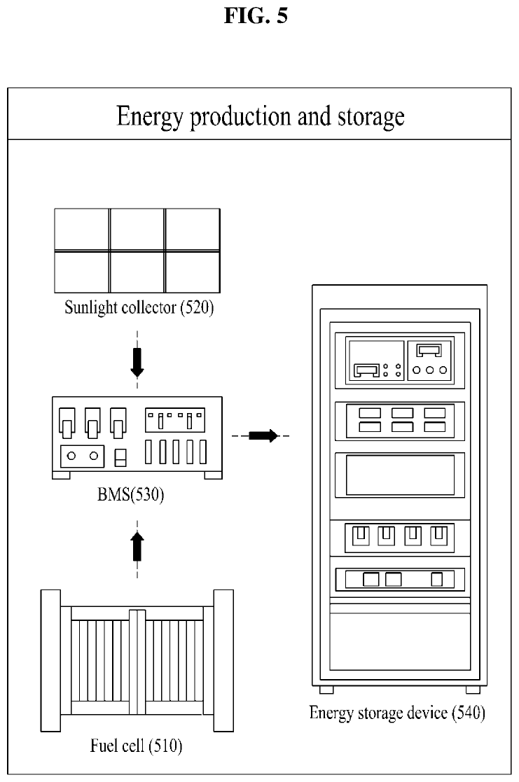

FIG. 5 is a diagram for describing an energy production and storage unit according to an embodiment of the present disclosure.

Energy converted from hydrogen, injected into the energy production and storage unit according to an embodiment of the present disclosure, through a fuel cell 510 and energy generated by a sunlight collector 520 are transferred to a BMS 530. An optimum energy production and storage process is performed through interoperation with the automatic control panel. Power generated through a stack of the fuel cells 510 is stored in an energy storage device 540, and may be used as emergency power. The energy production and storage unit may evaluate a storage state of dump power produced by the fuel cell 510, and may be designed as a bidirectional power conditioning system (PCS) for converting, into AC, power produced as DC and storing the AC.

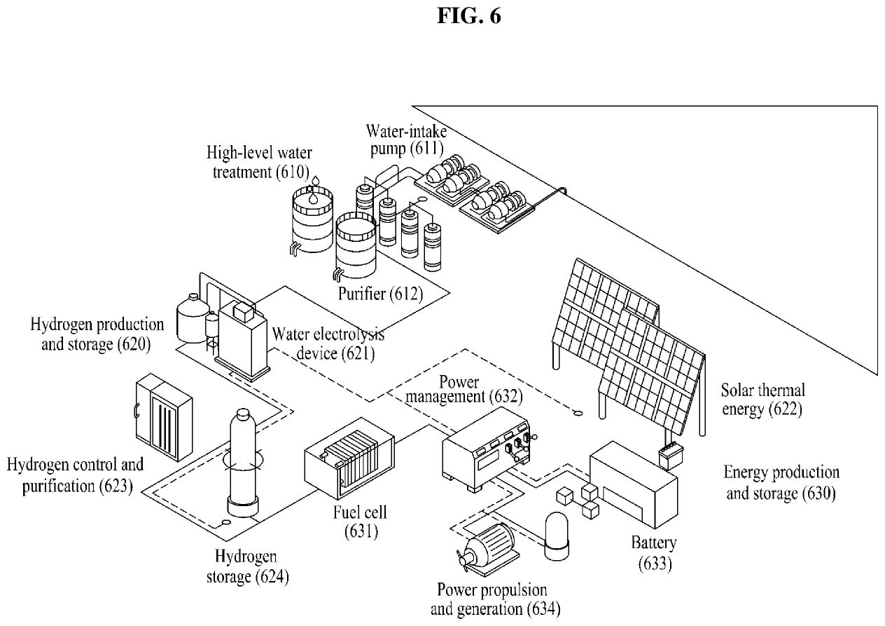

FIG. 6 is a diagram for describing an operating process of the self-contained hydrogen power system for an electric car charging station according to an embodiment of the present disclosure.

In high-level water treatment 610 according to an embodiment of the present disclosure, storm water, seawater, or portable water is retained in a water reserve tank, and precipitates are filtered out. The storm water, seawater, or portable water is primarily filtered through a screen within the water reserve tank. Thereafter, water supplied through a water-intake pump 610 is secondarily filtered through a filter. Thereafter, third filtering and purification treatment is performed on the water through UV and a membrane filter (612). In the present disclosure, emphasis has been placed on a treatment process for each water use, but the treatment process is performed through consecutive processes, including sedimentation, filtration, activated carbon adsorption, reverse osmosis, and high oxidation. A reactor is designed by considering a treatment level of a target value, an optimum injection concentration, light intensity, a contact time, or a characteristic for each water quality factor. Furthermore, system performance can be maintained with high efficiency for a long time by making, as a manual, timing at which each treatment target material is controlled, maintained and managed in an individual unit element system.

In a process for hydrogen production and storage 620 according to an embodiment of the present disclosure, the purified water is introduced into a water electrolysis device 621, and hydrogen electrolysis is performed on the purified water, thereby generating clean hydrogen. The water electrolysis process is efficiently performed using solar thermal energy 622 through a sunlight collector. The generated hydrogen is converted into high-purity clean hydrogen through a process for hydrogen control and purification 623 and is stored in a hydrogen tank (624). Thereafter, a given amount of hydrogen is periodically injected into an energy production and storage unit through an automatic control panel. Upon water electrolysis, the automatic control panel efficiently performs required power versus solar power generation efficiency through analysis.

In a process for energy production and storage 630 according to an embodiment of the present disclosure, energy converted from injected hydrogen through a fuel cell 631 and solar thermal energy 622 generated by the sunlight collector are transferred to a BMS for power management 632. An optimum energy production and storage process is performed through interoperation with the automatic control panel. Power generated by a stack of the fuel cells 631 is stored in an energy storage device, that is, a battery 633, and may be used as emergency power. The energy stored as described above may be used for power propulsion and generation 634. The energy production and storage unit may evaluate a storage state of dump power produced by the fuel cell 631, and may be designed as a bidirectional power conditioning system (PCS) for converting, into AC, power produced as DC and storing the AC.

FIG. 7 is a diagram illustrating a charging station according to an embodiment of the present disclosure.

As illustrated in FIG. 7, the charging station according to an embodiment of the present disclosure may receive energy stored in the energy production and storage unit and use the energy to charge an electric car. The charging station may include a dispenser for supplying energy and a dispenser controller. Furthermore, the charging station may include a temperature and pressure sensor for measuring a temperature and pressure of the charging station and a surrounding temperature sensor for measuring a surrounding temperature.

The charging station may use energy, received from the energy production and storage unit, in order to charge an electric car through a nozzle and a communication unit, and may indicate a charging quantity through a meter.

The aforementioned device may be implemented by a hardware component, a software component or a combination of a hardware component and a software component. For example, the device and components described in the embodiments may be implemented using one or more general-purpose computers or special-purpose computers, like a processor, a controller, an arithmetic logic unit (ALU), a digital signal processor, a microcomputer, a field programmable gate array (FPGA), a programmable logic unit (PLU), a microprocessor or any other device capable of executing or responding to an instruction. The processing device may perform an operating system (OS) and one or more software applications executed on the OS. Furthermore, the processing device may access, store, manipulate, process and generate data in response to the execution of software. For convenience of understanding, one processing device has been illustrated as being used, but a person having ordinary skill in the art may understand that the processing device may include a plurality of processing elements and/or a plurality of types of processing elements. For example, the processing device may include a plurality of processors or a single processor and a single controller. Furthermore, a different processing configuration, such as a parallel processor, is also possible.

Software may include a computer program, a code, an instruction or a combination of one or more of them and may configure a processing device so that the processing device operates as desired or may instruct the processing devices independently or collectively. The software and/or the data may be embodied in any type of machine, component, physical device, virtual equipment or computer storage medium or device in order to be interpreted by the processor or to provide an instruction or data to the processing device. The software may be distributed to computer systems connected over a network and may be stored or executed in a distributed manner. The software and the data may be stored in one or more computer-readable recording media.

The method according to an embodiment may be implemented in the form of a program instruction executable by various computer means and stored in a computer-readable medium. The computer-readable medium may include a program instruction, a data file, and a data structure solely or in combination. The medium may continue to store a program executable by a computer or may temporarily store the program for execution or download. Furthermore, the medium may be various recording means or storage means of a form in which one or a plurality of pieces of hardware has been combined. The medium is not limited to a medium directly connected to a computer system, but may be one distributed over a network. An example of the medium may be one configured to store program instructions, including magnetic media such as a hard disk, a floppy disk and a magnetic tape, optical media such as CD-ROM and a DVD, magneto-optical media such as a floptical disk, ROM, RAM, and flash memory. Furthermore, other examples of the medium may include an app store in which apps are distributed, a site in which other various pieces of software are supplied or distributed, and recording media and/or storage media managed in a server. Examples of the program instruction may include machine-language code, such as a code written by a compiler, and a high-level language code executable by a computer using an interpreter.

As described above, although the embodiments have been described in connection with the limited embodiments and drawings, those skilled in the art may modify and change the embodiments in various ways from the description. For example, proper results may be achieved although the above descriptions are performed in order different from that of the described method and/or the aforementioned components, such as the system, structure, device or apparatus, and circuit, are coupled or combined in a form different from that of the described method or replaced or substituted with other components or equivalents.

Accordingly, other implementations, other embodiments, and the equivalents of the claims fall within the scope of the claims.

The embodiments of the invention in which an exclusive property or privilege is claimed are defined as follows:

1. A self-contained hydrogen power system for an electric car charging station, comprising:
a high-level water purification unit configured to retain storm water, seawater or portable water in a water reserve tank, remove precipitates from the storm water, seawater or portable water, and perform water treatment on the storm water, seawater or portable water;
a solar water electrolysis unit configured to generate clean hydrogen through hydrogen electrolysis and store the clean hydrogen;
an energy production and storage unit configured to convert the clean hydrogen into energy through a fuel cell and perform an energy production and storage process by using energy generated by a sunlight collector; and
a charging station configured to receive the energy stored in the energy production and storage unit and use the energy to charge an electric car.

2. The self-contained hydrogen power system of claim 1, wherein the high-level water purification unit:
primarily filters the storm water, seawater or portable water through a screen within the water reserve tank,
secondarily filters the storm water, seawater or portable water through a filter,
thirdly filters and purifies the storm water, seawater or portable water through UV and a membrane filter, and
performs a treatment process for each use through consecutive processes comprising sedimentation, filtration, activated carbon adsorption, reverse osmosis, and high oxidation.

3. The self-contained hydrogen power system of claim 1, wherein the solar water electrolysis unit:
performs the hydrogen electrolysis by using solar thermal energy,
converts, into high-purity clean hydrogen, the hydrogen generated through the hydrogen electrolysis through a hydrogen purification process,
stores the high-purity clean hydrogen in a hydrogen tank, and
periodically injects a predetermined amount of clean hydrogen into the energy production and storage unit through an automatic control panel,
wherein the automatic control panel analyzes and controls required power versus solar power generation efficiency upon hydrogen electrolysis.

4. The self-contained hydrogen power system of claim 1, wherein the energy production and storage unit is:
transfers, to a battery management system (BMS), the energy converted from the injected clean hydrogen through the fuel cell and the energy generated by the sunlight collector,
controls optimum energy production and storage through interoperation with an automatic control panel of the solar water electrolysis unit, wherein power generated by a stack of the fuel cells is stored in an energy storage device and used as emergency power, and
evaluates a storage state of dump power produced by the fuel cell, convert, into AC, power produced as DC, and stores the AC.

5. A self-contained hydrogen power method for an electric car charging station, comprising steps of:
retaining storm water, seawater or portable water in a water reserve tank of a high-level water purification unit and performing water treatment on the storm water, seawater or portable water by removing precipitates,
injecting purified water into a solar water electrolysis unit, generating clean hydrogen through hydrogen electrolysis, and storing the clean hydrogen,
injecting the clean hydrogen into an energy production and storage device, converting the clean hydrogen into energy through a fuel cell, and performing an energy production and storage process on the clean hydrogen by using energy generated by a sunlight collector, and
receiving the energy stored in the energy production and storage unit through a charging station and using the energy to charge an electric car.

6. The self-contained hydrogen power method of claim 5, wherein the step of retaining storm water, seawater or portable water in a water reserve tank of a high-level water purification unit and performing water treatment on the storm water, seawater or portable water by removing precipitates comprises:
primarily filtering the storm water, seawater or portable water through a screen within the water reserve tank, secondarily filtering the storm water, seawater or portable water through a filter, and thirdly filtering and purifying the storm water, seawater or portable water through UV and a membrane filter, and
performing a treatment process for each use through consecutive processes comprising sedimentation, filtration, activated carbon adsorption, reverse osmosis, and high oxidation.

7. The self-contained hydrogen power method of claim 5, wherein the step of injecting purified water into a solar water electrolysis unit, generating clean hydrogen through hydrogen electrolysis, and storing the clean hydrogen comprises performing the hydrogen electrolysis by using solar thermal energy, converting, into high-purity clean hydrogen, the hydrogen generated through the hydrogen electrolysis through a hydrogen purification process, storing the high-purity clean hydrogen in a hydrogen tank, and periodically injecting a predetermined amount of clean hydrogen into the energy production and storage unit through an automatic control panel,
wherein the automatic control panel analyzes and controls required power versus solar power generation efficiency upon hydrogen electrolysis.

8. The self-contained hydrogen power method of claim 5, wherein the step of injecting the clean hydrogen into an energy production and storage device, converting the clean hydrogen into energy through a fuel cell, and performing an energy production and storage process on the clean hydrogen by using energy generated by a sunlight collector comprises:
transferring, to a battery management system (BMS), to the energy converted from the injected clean hydrogen through the fuel cell and the energy generated by the sunlight collector,
controlling optimum energy production and storage through interoperation with an automatic control panel of the solar water electrolysis unit, wherein power generated by a stack of the fuel cells is stored in an energy storage device and used as emergency power, and
evaluating a storage state of dump power produced by the fuel cell, converting, into AC, power produced as DC, and storing the AC.
